(19) United States
(12) Patent Application Publication
(10) Pub. No.: US 2022/0145219 A1
(43) Pub. Date: May 12, 2022

(54) Cleaning Composition

(71) Applicant: AUNT FANNIE INC., PORTLAND, OR (US)

(72) Inventors: Mathew John Franken, Portland, OR (US); Melissa Christenson, Buffalo, MN (US)

(73) Assignee: AUNT FANNIE INC., PORTLAND, OR (US)

(21) Appl. No.: 17/521,738

(22) Filed: Nov. 8, 2021

Related U.S. Application Data
(60) Provisional application No. 63/110,423, filed on Nov. 6, 2020.

(51) Int. Cl. C11D 3/382; C11D 17/06; C11D 1/18; C11D 1/12; C11D 3/20; C11D 3/10; C11D 3/12

(52) U.S. Cl. CPC C11D 3/382; C11D 17/06; C11D 1/18; C11D 3/124; C11D 3/2079; C11D 3/2086; C11D 3/10; C11D 1/126

(57) ABSTRACT

A composition of, and method of making, a cleaning composition and a cleaning powder is disclosed. The composition includes a desiccated surfactant, powdered vinegar, and optionally a custom essence.

### RELATED APPLICATIONS

The present patent document claims the benefit of the filing date under 35 U.S.C. § 119(e) of Provisional U.S. Patent Application Ser. No. 63/110,423, filed Nov. 6, 2020, which is hereby incorporated by reference in its entirety.

### BACKGROUND

Increasing consumer demand for environmentally friendly products is rapidly motivating companies that produce a wide range of products to compete for market share in this fast growing business sector. Many of these products are especially harmful to the environment due to excessive, single-use, plastic packaging.

Household cleaning products, for example, are typically sold in single-use, containers, including single use plastic containers. Accordingly, there is a need for household cleaning products that effectively clean kitchens, bathrooms, glass and windows, floors, and more without using excessive, single-use packaging.

### BRIEF SUMMARY

We disclose cleaning compositions and methods for making cleaning compositions. In a variation, the cleaning composition may be provided in the form of an unconcentrated powder. The powdered cleaning composition may be used in the powder form to clean surfaces. The cleaning composition may be directly applied to the surface desired to be cleaned in its dry form.

In another variation, the cleaning composition may be provided in the form of a concentrated powder. The concentrate may be provided in a partially, substantially, or fully desiccated form intended for reconstitution with a liquid before use.

In a variation, the cleaning composition may be provided in a powdered form. The cleaning composition may include, among other elements, sodium methyl cocoyl taurate, powdered vinegar, and a custom essence. The elements may be delivered in desiccated form or otherwise. In a variation, the method of making the powdered cleaning concentrate includes adding sodium methyl cocoyl taurate, adding powdered vinegar, and adding a custom essence. The steps may be performed in any order.

In another nonlimiting variation, a cleaning composition includes a surfactant, e.g., sodium cocoyl isethionate (or others listed below), sodium bicarbonate, citric acid, silica, powdered vinegar, and a custom essence. A method of making the cleaning composition includes adding sodium cocoyl isethionate, adding sodium bicarbonate, adding citric acid, adding silica, adding powdered vinegar, and adding a custom essence. The steps may be altered and the order of adding may be varied.

Other systems, methods, features, and advantages of the disclosure will be, or will become, apparent to one with skill in the art upon examination of the following detailed description. It is intended that all such additional systems, methods, features and advantages be included within this description, be within the scope of the invention, and be protected by the following claims.

### BRIEF DESCRIPTION OF THE DRAWINGS

FIG. 1 is a flow chart of a method of using a cleaning compound concentrate;

FIG. 2 is a flow chart of a method of using a cleaning powder; and

FIG. 3 is a flow chart of a method of making a cleaning composition.

### DETAILED DESCRIPTION

In the following description, for the purposes of explanation, numerous specific details are set forth in order to provide a thorough understanding of the claimed subject matter. It may be evident, however, that the claimed subject matter may be practiced without these specific details.

The singular terms “a,” “an,” and “the” include plural referents unless context clearly indicates otherwise. “Comprising A or B” means including A, or B, or A and B. Although methods and materials similar or equivalent to those described herein can be used in the practice or testing of the present disclosure, suitable methods and materials are described below. In addition, the materials, methods, and examples are illustrative only and not intended to be limiting. In case of conflict, the present specification, including explanations of terms, will control. The term “substantially” is defined as largely but not necessarily wholly what is specified (and includes what is specified; e.g., substantially 15 percent includes 15 percent), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a composition, or a component of a composition, that “comprises,” “has,” “includes” or “contains” one or more elements or features possesses those one or more elements or features, but is not limited to possessing only those elements or features. Likewise, a method that “comprises,” “has,” “includes” or “contains” one or more steps possesses those one or more steps, but is not limited to possessing only those one or more steps.

Terms such as “first” and “second” are used only to differentiate ingredients or features, and not to limit the different ingredients or features to a particular order or to a particular quantity. In order to facilitate review of the various embodiments of the disclosure, the following explanations of specific terms are provided.

“Cleaning composition concentrate” refers to a concentrated cleaning compound which is meant for dilution prior to use. This is contrasted with a “Cleaning Powder” which is meant for direct use without dilution.

“Cleaning powder” refers to a cleaning compound that is meant for direct application without dilution.

The following description of the various system and method is not intended to limit the inventive system and method disclosed herein to one variation, but rather to enable any person skilled in the art of making household cleaners and cleaning concentrates to make and use the inventive system and method.

More than 300 million tons of plastic are produced every year, and at least half is single-use plastic such as the plastic used for product packaging. Despite being utilized for an incredibly brief period of time, single-use plastics remain on the planet for hundreds of years. Household cleaners are one of countless products, and industries as a whole, that rely on single-use product packaging to supply repeat consumers with effective, convenient, ready-to-use products. In addition to pairing with single-use plastic packaging, many household cleaning products are detrimental to the environment for other reasons. For example, many cleaning products include harmful chemicals and have extensive carbon footprints relating to production and distribution of the products.

We disclose a composition and a method for making an environmentally-friendly, effective cleaning composition. In a first variation, the cleaning composition may be delivered as a cleaning composition dry powder or cleaning powder. In the first variation, after a consumer identifies a surface for cleaning, the cleaning powder is applied directly to the surface. The powder may then be distributed to the area with a sponge, cloth, towel, brush, or other item used for cleaning, hereinafter a “cleaning item.” The cleaning item may be wet during use or it may be dry during use. After the powder is applied, the cleaning solution may be removed from the surface by, e.g., rinsing, polishing, toweling, vacuuming, or otherwise.

The cleaning powder has a variety of uses including but not limited to the following. The cleaning powder may be used to clean glass, e.g., applied directly to a glass, e.g., a glass shower door. The cleaning powder may be used to clean metal object, e.g., bathroom fixtures such as a shower head, e.g., applied directly to the metal object. The cleaning powder may be used to clean tile and/or grout, e.g., applying the cleaning powder directly to the grout or tile. The cleaning powder may be used to clean an appliance, e.g., a stove top, e.g., applied directly to the stove top. The cleaning powder may be used to spot remove from fabric, e.g., clothing or furniture or shoes, e.g., applying directly to the fabric. The cleaning powder may be used to clean used kitchen pots or pans, e.g., applying directly to the kitchen pots or pans. The cleaning powder may be used to clean outdoor decking or siding, e.g., applying directly to the outdoor decking or siding.

In a second variation, the cleaning composition may be delivered as a cleaning composition concentrate. In a further example the cleaning composition concentrate may be delivered in a concentrated powdered form that can be reconstituted with water. The cleaning composition concentrate has a variety of uses including as a cleanser on kitchen and bathroom surfaces, floors, and glass and windows, as non-limiting examples. The disclosed cleaning composition concentrate can be distributed and sold in a desiccated form (which may be partially desiccated, substantially desiccated, or desiccated form).

By delivering the cleaning composition concentrate in a concentrated form, it may be delivered to the client in an efficient sized packaging. The efficient sized packaging may have reduced materials as compared to traditional single use packaging. The cleaning composition concentrate so delivered may then be deposited into a multi-use container. In some variations, the cleaning composition concentrate is deposited into a multi-use container where it is reconstituted with a liquid, including but not limited to, water.

Delivering the cleaning composition concentrate in a powdered form eliminates the need for single-use plastic packaging. Additionally, manufacturing and distribution of the cleaning composition concentrate requires less energy compared to conventional high-water content household cleaners, further reducing the carbon footprint. The disclosed cleaning composition concentrate and cleaning powder does not include harmful, synthetic or petrochemical-derived ingredients. The presently disclosed composition and method is more environmentally-friendly than existing solutions.

In a variation, the cleaning composition is generally a vinegar-based, concentrated, partially, substantially, or fully waterless powder formula with up to 100% plant-based ingredients. Vinegar has its common definition, e.g., having acetic acid as a component. In a variation, the cleaning composition is a free-flowing powder concentrate that is faster dissolving than other solid cleaning concentrates currently available. In a further variation, the cleaning composition concentrate and/or cleaning powder cleans as effectively as a commercially available ready-to-use liquid cleaner. In a further variation the vinegar powder may be a dry white distilled vinegar.

In one nonlimiting variation, the cleaning composition includes a surfactant and a powdered vinegar, which surfactant may be any surfactant listed herein. In a variation, the surfactant may be sodium methyl cocoyl taurate and/or Sodium Cocoyl Isethionate and powdered vinegar. The sodium methyl cocoyl taurate and/or Sodium Cocoyl Isethionate, among other things, acts as a surfactant and aids in cleaning. The vinegar, among other things, provides acidity and enhanced cleaning and solvency. Advantageously, the composition is self-preserving in powdered form and when diluted due to the low pH of vinegar, and no preservatives are required. In certain variations, the pH of the composition when diluted is greater than 0 and less than 7. In other variations, the pH of the composition when diluted is greater than 2 and less than 5.

In certain nonlimiting variations, a custom essence is added to the surfactant and powdered vinegar composition. The custom essence is included to provide an appealing, pleasant aroma when using the powdered cleaning concentrate. In certain variations, one or more liquid essential oils are used. In a variation the surfactant, e.g., Sodium Cocoyl Isethionate and/or sodium methyl cocoyl taurate enhances the solubility of the essential oils.

In yet another nonlimiting variation, the cleaning composition, which may be a cleaning powder and/or it may be a cleaning composition concentrate, includes sodium cocoyl isethionate and/or Sodium Cocoyl Isethionate, sodium bicarbonate, citric acid, optionally a silica, and desiccated vinegar (e.g., vinegar powder). The sodium cocoyl isethionate and/or Sodium Cocoyl Isethionate, among other things, acts as a surfactant and aids in cleaning. The sodium bicarbonate and citric acid add additional cleaning properties to the composition. The silica is used to maintain a free-flowing powder. The vinegar provides acidity and enhanced cleaning and solvency. Advantageously, the composition is self-preserving in powdered form, such as a cleaning powder and/or a powdered cleaning concentrate. No preservatives are required in either the cleaning powder, the powdered cleaning concentrate, and/or the diluted powdered cleaning concentrate. In certain variations, the pH of the composition when diluted is greater than 0 and less than 7. In certain preferred variations, the pH of the composition when diluted is greater than 2 and less than 5.

Throughout the disclosure, reference to surfactant may be any known or later surfactant, such as but not limited to a plant based surfactant. A non-limiting list of surfactants follows: sodium methyl cocoyl taurate, Sodium Cocoyl Isethionate, brassicamidopropyl dimethylamine and salts thereof(amine), sodium coco sulfate, sodium lauryl sulfate, sodium laureth sulfate, lauryl glucoside, ammonium lauryl sulfate, ammonium laureth sulfate, sodium myristyl sulfate, yucca extract, quillaja saponaria extract, sapindus mukorossi extract, behentrimonium and salt thereof(ammonium), decyl glucoside, shikakai extract, sodium lauroyl sarcosinate, capryl/decyl clucoside, sodium lauryl sulfoacetate, stearyl dihydroxypropyldimonium oligosaccharides, coco glucoside, cocamidopropyl betain, sodium cocoyl glycinate, sodium cocoyl/lauroyl glutamate, sodium cocoyl isethionate, sodium cocoyl/lauryl taurate, sodium C14-16 olefin sulfonate, diethylhexyl sodium sulfosuccinate, disodium lauryl sulfosuccinate, cocomidapropyl hydroxysultaine, cocomidapropyl betaine, brassicyl isoleucinate esylate, sodium myreth sulfate, and similar.

In certain nonlimiting variations, a custom essence is added to the surfactant (e.g., sodium cocoyl isethionate and/or Sodium Cocoyl Isethionate), sodium bicarbonate, and powdered vinegar composition. Where “essence” is mentioned in a formula or chart, it may be one essence or it may be a combination of essence. The custom essence is included to provide an appealing, pleasant aroma when using the cleaning concentrate. In certain variations, one or more liquid essential oils are used, and the surfactant, e.g., sodium cocoyl isethionate, enhances the solubility of the essential oils. The silica limits the total amount of composition needed to absorb the essential oils. The custom essence may be any essence or oil that is, e.g., extracted from a plant, such as by distillation (e.g., steam distillation), centrifugal, solvent extraction, and the like, or other fluid produced from such oils, in a manner that results in a highly concentrated and often volatile (i.e., having a tendency to evaporate at room temperature) oil. An exemplary custom essence may include but is not limited to, a first version: Litsea Cubeba Fruit Oil, Mentha Piperita (Peppermint) Oil, Citrus Limon (Lemon) Peel Oil, Citrus Aurantium Dulcis (Orange) Peel Oil, Mentha Virdis (Spearmint) Leaf Oil; a second version: Rosmarinus Officinalis (Rosemary) Leaf Oil, Eucalyptus Globulus (Eucalyptus) Oil, Mentha Piperita (Peppermint) Oil, Citrus Aurantium Dulcis (Orange) Peel Oil, Lavandula Hybrida (Lavandin) Oil; a third version: Juniperus Communis (Juniper Berry) Fruit Oil, Citrus Nobilis (Mandarin Orange) Peel Oil, Citrus Tangerina (Tangerine) Peel Oil, Citrus Aurantium Dulcis (Orange) Peel Oil, Citrus Paradisi (Graperfruit) Peel Oil; and/or a fifth version: Juniperus Mexicana Oil, Rosmarinus Officinalis (Rosemary) Leaf Oil, Lavandula Angustifolia (Lavender) Oil, Eucalyptus Globulus (Eucalyptus) Oil, Lavandula Hydride (Lavandin) Oil; a fourth version: Rosmarinus Officinalis (Rosemary) Leaf Oil, Eucalyptus Globulus (Eucalyptus) Oil, Mentha Piperita (Peppermint) Oil, Citrus Aurantium Dulcis (Orange) Peel Oil, Lavandula Hybrida (Lavandin) Oil; a fifth version: Litsea Cubeba Fruit Oil, Mentha Piperita (Peppermint) Oil, Citrus Limon (Lemon) Peel Oil, Citrus Aurantium Dulcis (Orange) Peel Oil, Mentha Virdis (Spearmint) Leaf Oil.

The essence used herein may further include any one or more of the following illustrative and non-limiting examples: Carrot seed oil, Cassia oil, Cedar (e.g., Western Red) oil, Cedarwood oil, Celery seed oil, Chamomile oil (e.g., German, Roman, etc.), Cinnamon Bark oil, Cistus citronella oil, Citrus hysteix oil, Clary Sage oil, Clove oil, Copaiba oil, Coriander oil, Cumin oil, Cypress oil (e.g., Blue), Davana oil, Dill oil, Dorado Azulejo oil, Elemi oil, Eucalyptus oil (e.g., Blue, Citriodora. Dives, Globus, Lemon, Polybractea, Radiata, etc.), Fennel oil, Flax oil, Douglas Fir oil, White Fir oil, Frankincense oil, Ginger oil, Goldenrod oil, Grapefruit oil, Helichrysum oil, Hemp oil, Hyssop oil, Jasmine oil, Jojoba oil, Juniper oil, Laurus Nobilis oil, Lavandin oil, Lavender oil, Ledum oil, Lemon oil, Lemongrass oil, Lime oil, Mandarin oil, Manuka oil, Marjoram oil, Melaleuca oil (e.g., Alternifolia, Cajeput, Ericifolia, Quinquenervia), Melissa oil, Mountain Savory oil, Menthol oil, Mugwort oil, Myrrh oil, Myrtle oil, Neem oil, Neroli oil, Nutmeg oil, Ocotea oil, Olive oil, Orange oil, Oregano oil, Palmarosa oil, Palo Santo oil, Patchouli oil, Black Pepper oil, Petitgrain oil, Pine oil, Primrose oil, Ravintsara oil, Rose oil, Rosemary oil, Rosewood oil, Sage oil (e.g., Spanish), Sandalwood oil, Spearmint oil, Spikenard oil, Spruce oil, Sweet Basil Oil, Tangerine oil, Tansy oil (e.g., Blue, Idaho, etc.), Tarragon oil, Tea Tree oil, Thyme oil, Tsuga oil, Valerian oil, Vetiver oil, White Lotus oil, Wintergreen oil, and Yarrow oil.

A basic formulation for cleaning composition concentrate is shown in Table 1 below. Table 1 includes the percentage of each ingredient in the various compositions and the overall percentage of each ingredient in the solution formed by mixing the compositions with water prior to use. The variation shown in Tables 1 are especially well suited for use on household, industrial, automobile, kitchen and bathroom surfaces and floors, as nonlimiting examples. Where a range is given throughout this disclosure, it is intended that each value in the range is disclosed, for example, if the range is 14.5% to 19.5%, the actual value may be any individual concentration in that range, e.g., 14.6%, 15.55%, 18.90%, etc.

TABLE 1
Cleaning Concentrate

| | % IN | ACTUAL % IN |
|---|---|---|
| | CONCENTRATE | SOLUTION |
| Essence | 14.5%-19.5% | 0.5%-1.0% |
| Surfactant, e.g., Sodium Methyl | 8.0%-12.00% | .30%-2.2% |
| Cocoyl Taurate | | |
| Vinegar powder | 70.0%-79.0% | 2.0%-5.9% |
| Total | 100% | 3.00%-9.00% |

What follows is an exemplary discussion of formula variations, a cleaning composition concentrate for dilution as approximately 20 g of concentrated product in 500 mL of liquid, such as but not limited to water, for an approximately 4.00% solution. In an first example variation, a 60 g unit (e.g., three 20 g uses) may include approximately 10 g-11 g essence powder to 15.25-17.75% of the concentrate and yielding 0.50-0.75% in solution after dilution, a plant based surfactant approximately 5.80 g-6.20 g making up approximately 9.80%-10.20% of the concentrate and yielding approximately 0.35%-0.45% in solution after dilutions, and a powdered vinegar at 42.50 g-44.00 g making up approximately 71.50%-73.50% of the concentrate and yielding approximately 2.70%-3.1% in solution after dilution.

In a second example variation, a 60 g unit cleaning composition concentrate (e.g., three 20 g cleaning composition concentrate uses) may include approximately 8.5 g-9.5 g essence powder to 14.75-15.25% of the concentrate and yielding 0.50-0.65% in solution after dilution, a plant based surfactant approximately 5.80 g-6.20 g making up approximately 9.80%-10.20% of the concentrate and yielding approximately 0.35%-0.45% in solution after dilutions, and a powdered vinegar at 44.50 g-45.50 g making up approximately 74.50%-75.50% of the concentrate and yielding approximately 2.90%-3.2% in solution after dilution.

In a third example variation, a 60 g unit cleaning composition concentrate (e.g., three 20 g cleaning composition concentrate uses) may include approximately 10.0 g-10.5 g essence powder to 17.25-17.75% of the concentrate and yielding approximately 0.65%-0.75% in solution after dilution, a plant based surfactant approximately 5.80 g-6.20 g making up approximately 9.80%-10.20% of the concentrate and yielding approximately 0.35%-0.45% in solution after dilutions, and a powdered vinegar at 43.00 g-44.25 g making up approximately 72.00%-74.00% of the cleaning composition concentrate and yielding approximately 2.70%-3.1% in solution after dilution.

A composition for a variation of a cleaning composition concentrate is shown in Table 2 below. Table 2 includes the percentage of each ingredient in the composition and the overall percentage of each ingredient in the solution formed by mixing the cleaning composition concentrate with water prior to use. In the example of Table 2, it is assumed that the cleaning composition concentrate is delivered in 60 g product. It will be obvious to one of skill in the art how to change the proportions to accommodate a larger or smaller product size, e.g., 20 g product or 100 g product, etc. The cleaning composition concentrate product is diluted for use by adding approximately 20 g of product to approximately 500 ml of water. The nonlimiting variation shown in Table 2 is especially well suited for use on glass and windows, as nonlimiting examples.

TABLE 2
Cleaning Concentrate

| | Grams/% IN | ACTUAL % IN |
|---|---|---|
| | CONCENTRATE | SOLUTION |
| Essence | 4.00 g-4.40 g | 0.20-0.38% |
| | 6.50%-7.50% | |
| Surfactant, e.g., Sodium Methyl | 5.80 g-6.20 g | 0.35%-0.45% |
| Cocoyl Taurate | 9.5%-10.5% | |
| Vinegar | 43.0 g-44.0 | 3.50%-3.9% |
| | 87.0%-89.0% | |
| Total | 100% | Approx 4% |
| | 60 g | |

We disclose a composition and a method for making an environmentally-friendly, effective cleaning powder. In the cleaning powder variation, the cleaning powder may be delivered as a dry powder. In the cleaning powder, after a consumer identifies a surface for cleaning, the cleaning composition is applied directly to the surface. The powder may then be distributed to the area with a sponge, cloth, towel, brush, or other item used for cleaning, hereinafter a “cleaning item.” The cleaning item may be wet during use or it may be dry during use. After the powder is applied, the cleaning solution may be removed from the surface by, e.g., rinsing, polishing, toweling, vacuuming, or otherwise.

An exemplary formula for the cleaning powder are shown in Table 3 below. In Table 3 we demonstrate a first cleaning powder which may be used directly, meaning, without dilution. Table 3 include the grams and approximate percentage of each ingredient in the cleaning powder. The nonlimiting variations shown in Table 3 are especially well suited for use on toilet bowls, sinks, and garbage disposals, as nonlimiting examples. The following cleaning powder is used without dilution. In the example, approximately 20 g of cleaning powder is used and applied directly to the area for cleaning. The example is a 60 g cleaning powder product to show approximate grams used. One of skill would know how to adjust the grams to reach the desired product weight for distribution or use.

TABLE 3
Cleaning Powder for direct use

| | | % IN |
|---|---|---|
| | Grams | CONCENTRATE |
| Surfactant, e.g., Sodium Cocoyl | 8.5-9.5 g | ~15.0% |
| Isethionate | | |
| Sodium Bicarbonate | 23.5-24.5 g | ~45.0%- |
| Citric Acid | 11.5 g-12.5 g | ~25.0% |
| Silica | 2.5 g-3.5 g | ~10.0% |
| Vinegar powder | 5.5 g-6.5 g | ~15.0% |

We disclose a composition and a method for making an environmentally-friendly, effective cleaning composition. In a cleaning powder, the cleaning powder may be delivered as a cleaning powder dry powder. In the following variation, after a consumer identifies a surface for cleaning, the cleaning powder is applied directly to the surface. The cleaning powder may then be distributed to the area with a sponge, cloth, towel, brush, or other item used for cleaning, hereinafter a “cleaning item.” The cleaning item may be wet during use or it may be dry during use. After the cleaning powder is applied, the cleaning solution may be removed from the surface by, e.g., rinsing, polishing, toweling, vacuuming, or otherwise. Any cleaning powder herein may be left to “soak” or otherwise there may be a period of time between application and removal of the product.

A formula for a cleaning powder is shown in Table 4 below. In Table 4 we demonstrate a cleaning powder which may be used directly, meaning, without dilution. Table 4 include the grams and approximate percentage of each ingredient in the cleaning powder. The nonlimiting variations shown in Table 4 are especially well suited for use on toilet bowls, sinks, garbage disposals, dishwashers, decks, siding, cooking utensils, metal items, as nonlimiting examples. The following cleaning powder is used without dilution. In the example, approximately 20 g of cleaning powder is used and applied directly to the area for cleaning. The example is a 60 g cleaning powder product to show approximate grams used. One of skill would know how to adjust the grams to reach the desired product weight for distribution or use.

TABLE 4
Cleaning Powder for direct use
Amount in one 20 g use portion

| | | % IN |
|---|---|---|
| | Grams | PRODUCT |
| Surfactant, e.g., Sodium methyl | ~1.75-2.25 g | ~9.5-10.5% |
| cocoyl taurate | | |
| Sodium Bicarbonate | 0.18-0.22 g | ~.0028-.0040% |
| Vinegar powder | 17.5 g-18.5 g | ~88.5%-91.5% |
| Total | 20 g | 100% |

A method of making the cleaning compositions according to one variation includes adding a surfactant, e.g., any listed above, to powdered vinegar. In a variation, the surfactant may be, e.g., sodium methyl cocoyl taurate and/or Sodium Cocoyl Isethionate. In certain variations, a custom essence is also added. A method of making a powdered vinegar cleaner according to another variation includes adding a surfactant, adding sodium bicarbonate, adding citric acid, adding silica, and adding powdered vinegar. In certain variations, a custom essence is also added.

More specifically, in an illustrative example, in a blending vessel suitable for dry powders, dry vinegar, the dry vinegar spray dried with maltodextrin or tapioca starch, powdered surfactant (sodium methyl cocoyl taurate or sodium cocoyl isetionate), and liquid essential oils are blended until homogeneous. Additional ingredients such as sodium bicarbonate, citric acid, and silica may also be added in certain variations before or after blending. The resulting composition is filled into individual packets or bulk packages. The packets and packages provide a sufficient barrier for the essential oils in the powder by using flexible film with a foil lining, water soluble film lining, glass, aluminum, stainless steel, or any other suitable material. The packets and packages are configured to allow for easy pouring of the composition during use.

A method of using the cleaning composition according to certain variations includes pouring the cleaning composition into a reusable spray container and diluting the composition with water. In certain variations, the cleaning composition is diluted in 500 ml of water, however, other suitable volumes of water may be used. Using certain variations, a range of 5-35 grams of powdered cleaning concentrate is diluted in water. Using certain preferred variations, a range of 10-30 grams of powdered cleaning concentrate is diluted in water. In further variations, 20 g of powdered cleaning concentrate is diluted in water. Using certain variations, the powdered cleaning concentrate makes up between 0.05% and 10.0% of the solution formed by mixing the powdered cleaning concentrate with water. Using certain preferred variations, the powdered cleaning concentrate makes up between 2.0% and 6.0% of the solution formed by mixing the powdered cleaning concentrate with water. Using certain variations, the powdered cleaning concentrate is directly applied to applicable surfaces for cleaning and dilution is not needed.

The disclosed cleaning compositions may be sold in powdered form thereby eliminating the need for single-use plastic packaging. Additionally, manufacturing and distribution of the disclosed cleaning compositions uses less energy compared to conventional high water content household cleaners. As a result, the cleaning compositions are a more environmentally friendly solution to water-based, liquid, ready-to-use household cleansers, and have a lower carbon footprint. The novel cleaning compositions do not include sulfates, artificial dyes, synthetic fragrances, processing aids, preservatives or harmful synthetic or petrochemical-derived ingredients. The above described variations of the powdered cleaning concentrates effectively clean kitchens, bathrooms, glass and windows, floors, and more without the use of excessive, single-use plastic packaging.

The drawings include graphical representations of exemplary formulations for the cleaning compositions. It should be understood that actual values may fall within +1-0.5-5.0%, 0.1-1.0%, 0.2-2.0%, 0.3-3.0%, 0.4-4.0%, 0.6-6.0%, 0.7-7.0%, 0.8-8.0%, 1.0-10% of any value listed in the drawings, regardless of the units or designation of the value. For example, regardless of whether it is displayed as a percent, a volume, or a weight.

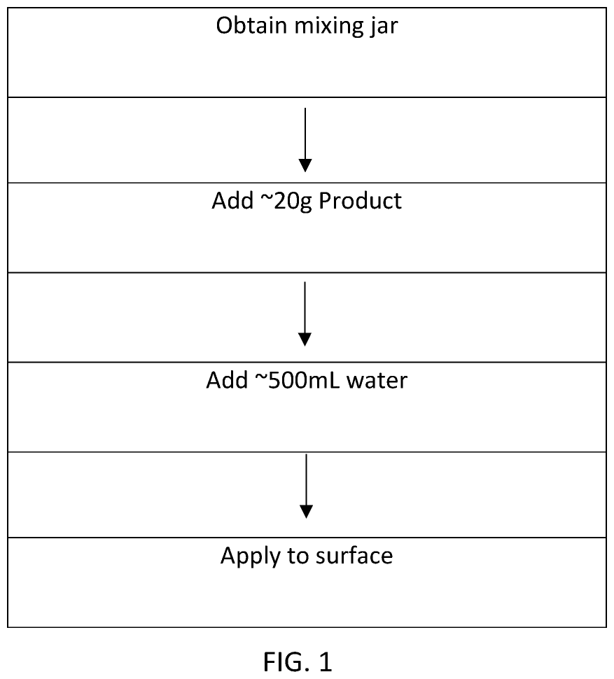

Turning to FIG. 1, we provide a method of using the cleaning concentrates. This is a non-limiting example. In this example, the product is provided in a concentrate. An amount of the concentrate is added to a mixing container. The mixing container may be, e.g., a spray bottle. In this example, 20 g of product is added to the mixing container. This is followed by adding 500 mL of water to the mixing container. After mixed, the user can apply the diluted cleaner to the surface.

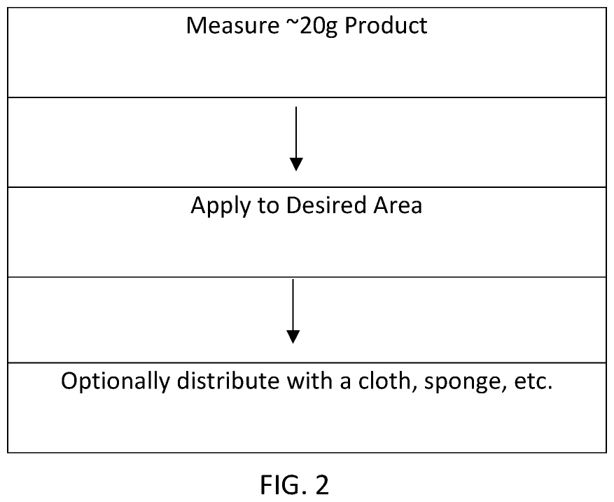

Turning to FIG. 2, we provide a method of using the powdered cleaner. In this non-limiting example, the user measures 20 g of the powdered cleaner. The powdered cleaner is used without dilution. The user may use a cloth, sponge, brush, or other implement to distribute the cleaner over the area desired to be cleaned.

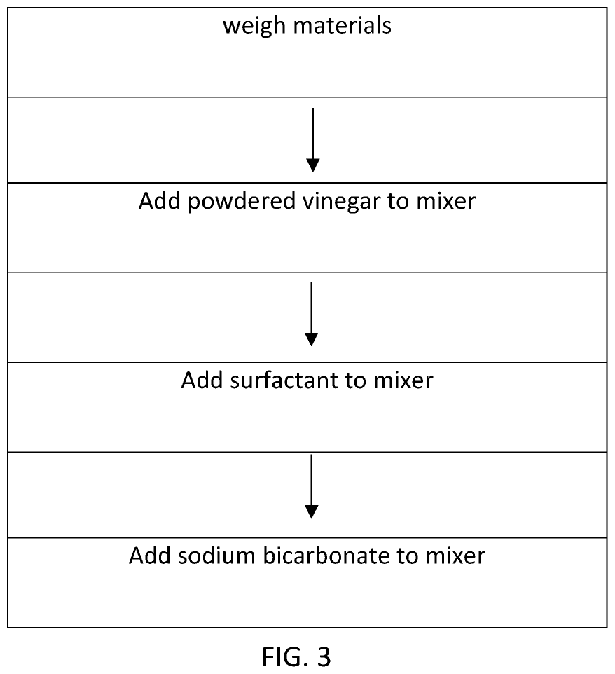

Turning to FIG. 3, we provide an exemplary method of making the cleaners of this disclosure. Materials are weighed and added to a mixer, which may be a ribbon mixer. Then the product is packaged for sale.

The invention is not limited to the variations described, as it also covers all equivalent implementations insofar as they do not depart form the spirit of the invention. Further, the invention is not yet limited to the combination of features as described herein but may be defined by any other combination of all of the individual features disclosed. Further, the invention is not yet limited to the sequence of method steps as described herein but may be defined by any other combination or order the steps disclosed. Any person skilled in the art will recognize from the previous detailed description and from the claims that modifications could be made to the disclosed embodiments of the invention without departing from the scope of the invention.

1. A cleaning composition concentrate, the composition comprising:
a. powdered plant essence;
b. powdered sodium methyl cocoyl taurate or Sodium Cocoyl Isethionate; and
c. vinegar powder.

2. The composition of claim 1, wherein the vinegar powder is a white distilled powdered vinegar.

3. The composition of claim 1, wherein the sodium methyl cocoyl taurate or Sodium Cocoyl Isethionate is in an amount between 9.5% and 10.5.0%, the vinegar powder is in an amount between 70.0% and 85.00%, and the essence is in an amount between 16.00% and 18.00% of the total concentrate.

4. A cleaning powder composition comprising:
a. Vinegar powder;
b. powdered sodium methyl cocoyl taurate or Sodium Cocoyl Isethionate; and
c. sodium bicarbonate powder.

5. The cleaning powder of claim 4, wherein the sodium methyl cocoyl taurate or Sodium Cocoyl Isethionate is in an amount between 9.5% and 10.5.0%, the vinegar powder is in an amount between 87.0% and 91.00%, and the sodium bicarbonate is in an amount between 0.50% and 1.50% of the total composition.

6. A cleaning powder comprising:
a. sodium cocoyl isethionate;
b. sodium bicarbonate;
c. citric acid;
d. silica; and
e. vinegar powder.

7. The composition of claim 6, wherein the composition includes a custom essence.

8. The composition of claim 17, wherein the sodium cocoyl isethionate is in an amount between 9.5% and 11.0%, the sodium bicarbonate is in an amount between 38.0% and 42.0%, the citric acid is in an amount between 18% and 22.0%, the silica is in an amount between 4.0% and 6.0%, and the vinegar powder is in an amount between 9% and 11.0%.
